(19) United States
(12) Patent Application Publication
(10) Pub. No.: US 2022/0242014 A1
(43) Pub. Date: Aug. 4, 2022

(54) Method and Gasket for Producing a Polymethyl Methacrylate Plate

(71) Applicant: Heathland Holding B.V., Utrecht (NL)

(72) Inventors: Nikolaj Garnitsch, Utrecht (NL); Simon van der Heijden, Utrecht (NL)

(21) Appl. No.: 17/610,021

(22) PCT Filed: May 10, 2020
(86) PCT No.: PCT/NL2020/050299

§ 371 Date: Nov. 9, 2021

(30) Foreign Application Priority Data
May 10, 2019 (NL) 2023107

(51) Int. Cl. B29C 39/26; B29C 39/10

(52) U.S. Cl. CPC B29C 39/265; B29K 2033/12; B29C 39/10

(57) ABSTRACT

The invention relates to a method for producing a polymethyl methacrylate plate, comprising the steps of providing a mould comprising at least one gasket which is enclosed between two substantially parallel mould parts, introducing liquid comprising methyl methacrylate prepolymer and/or methyl methacrylate monomer in the mould and enabling polymerization of the liquid methyl methacrylate. The invention also relates to a gasket for use in a mould for producing a polymethyl methacrylate plate.

### CROSS-REFERENCE TO RELATED APPLICATIONS

This application is the United States national phase of International Application No. PCT/NL2020/050299 filed May 10, 2020, and claims priority to Netherlands Patent Application No. 2023107 filed May 10, 2019, the disclosures of which are hereby incorporated by reference in their entirety.

### BACKGROUND OF THE INVENTION

### 1. Field of the Invention

The invention relates to a method for producing a polymethyl methacrylate plate. The invention also relates to a polymethyl methacrylate plate produced via said method. The invention further relates to a gasket for use in a mould for producing a polymethyl methacrylate plate and to such mould.

### 2. DISCUSSION OF THE RELATED ART

Polymethyl methacrylate (PMMA) is a transparent thermoplastic material which is widely used for several application, such as for example optical applications. PMMA is popular due to its extraordinary (material) properties, for instance with respect to weatherability and scratch resistance. The material is furthermore known for its good impact strength and good chemical resistance. PMMA is available commercially in both pellet and sheet or plate form. PMMA sheets can form a lightweight or shatter-resistant alternative to glass and are also known as acrylic, acrylic glass, or plexiglass. Production of a PMMA sheet is typically done by cell casting using two parallel glass panels which are separated via a gasket, wherein said gasket is clamped in between the glass panels. Hence, the glass panels and gasket form a casting cell which can contain a casting liquid. The casting liquid, typically methyl methacrylate (MMA) monomer or MMA prepolymer, is poured between the two glass panels and is subsequently subjected to a polymerization step resulting in a polymethyl methacrylate sheet being formed within the boundaries of the gasket. The glass panels are removed after the polymerization. Conventional gaskets used for the casting of PMMA are typically made of rubber or polyvinyl chloride (PVC). After polymerization of the PMMA sheet, the gasket has to be removed from the sheet. This is typically done by cutting (or trimming) of the edges of the sheet. The gasket and some polymer scrap, which is possibly adhered to the gasket, is then separated from the final PMMA sheet. A drawback of using rubber is that the (P)MMA sticks to rubbery material, making it difficult to separate the rubber and the PMMA scrap. This is also the case when using a gasket made of PVC. A further drawback of the use of PVC is that the use of this type of plastic is undesired from environmental point of view since it is rather difficult to recycle PVC. Leftover or residue containing PVC still often ends up in landfill, wherefore omitting the use of PVC would be highly desirable.

Hence, it is a goal of the invention to provide at least an alternative to the use of PVC or rubber as gasket in a mould when producing a PMMA sheet.

The invention provides thereto a method as described herein.

### SUMMARY OF THE INVENTION

The method according to the present invention is in particular a method for manufacturing a cast polymethyl methacrylate plate, i.e. a method for cell casting of a polymethyl methacrylate plate. Where the term plate is used, also a sheet is referred to. In the method according to the present invention a gasket comprising polymethyl methacrylate is used, which has several benefits over conventional methods which typically make use of a rubber or PVC gasket. The liquid comprising (poly)methyl methacrylate prepolymer and/or methyl methacrylate monomer is introduced into the mould cavity of the mould, such that the mould is substantially fully filled with liquid. The mould can also be referred to as casting cell. It is conceivable that the substantially flat mould surfaces facing of the opposing mould parts partially, or fully, engage another before MMA liquid is introduced in the mould. The liquid comes into direct contact with at least part of the gasket when introduced in the mould. The mould parts are removed after polymerization of the liquid. This can for example be done by removal of the clamping connection between the mould parts. A PMMA plate which is enclosed between the gasket is obtained. The PMMA plate can be at least partially bound or connected to the gasket. As mentioned above, typically the circumferential sides or edges of the casted PMMA plate are removed after the casting in order to obtain a final product in the form of an uncontaminated PMMA plate. This can be done via cutting or trimming. In particular, the gasket and part of the edges of the fabricated PMMA plate are removed. This removed scrap or residue contains PMMA from the produced plate in combination with PMMA of the gasket used in the mould. Since the gasket according to the present invention comprises PMMA, the scrap mainly and possibly substantially fully consists of PMMA. This results in the scrap being relatively easily processable for further application. Hence, the method according to the present invention substantially provides a single residual flow. The PMMA scrap can for example be recycled and/or depolymerised. Several known techniques can be applied for the recycling and/or depolymerization of PMMA wherein MMA with purity of more than 98% is obtainable. When it is referred to PMMA scrap, also polymer scrap, acrylic scrap or residue is meant.

The method according to the invention can also benefit from the material properties of the gasket in a further way. When the MMA liquid is introduced into the mould cavity of the mould, such that the mould is substantially fully filled with liquid, the liquid herewith comes into direct contact with at least part of the gasket when introduced in the mould. As a consequence of the direct contact, the MMA monomer or MMA prepolymer in the liquid may cause part of the PMMA of the gasket to dissolve within the liquid. Typically, during production of the PMMA plate at least part of the outer surface of the gasket, which is in direct contact with the MMA liquid, will dissolved within the MMA liquid. The degree of dissolution depends, amongst others, on the temperature of the liquid and/or the contact wetting surface. A relatively strong bonding between the gasket and the plate can hence be obtained. Since the gasket comprises PMMA this does not fundamentally affect the composition of the scrap after trimming of the PMMA plate. The contact between the MMA monomer or prepolymer and the gasket may also result in a connection between the PMMA of the plate and the gasket. Contact between the MMA monomer or prepolymer and the gasket furthermore typically causes at least part of the PMMA of the gasket to expand or swell. Due to the swelling of the gasket, an improved sealing of the mould by the gasket can be obtained when applying the method according to the present invention. The gasket is enclosed between two substantially parallel mould parts in the mould, which mould parts are typically clampingly connected to each other. Due to the clamping configuration, swelling of at least part of the gasket will result in the gasket being pressed outwardly towards the mould parts which results in at least partial deformation of the gasket. Due to this swelling, and thus deformation, the gasket can provide an improved sealing such that leakage of liquid from the mould can be prevented.

The method according to the present invention is in particular suitable for batch casting of PMMA plates. It is however also possible to apply the method in a continuous casting process. The gasket is typically only used once, thereafter the gasket needs to be further processed, such as recycled and/or depolymerized. The panes are typically configured for repeated use. The polymerization can be performed via any of the known PMMA polymerization techniques, for example by heating of the liquid at a predetermined temperature for a predetermined time interval. An oven may possibly be used for the step of polymerization. The desired polymerization parameters such as temperature and/or time depend on several process factors and are known by a person skilled in the field. It is conceivable that the method comprises the step of degassing of liquid before the liquid is introduced into the mould and/or before polymerization is initiated. When it is referred to MMA liquid, also a syrup or fluid comprising MMA monomer and/or MMA prepolymer can be meant. A MMA prepolymer can also be referred to as PMMA prepolymer. This prepolymer can be for example prepared from inhibitor which is heated possible in combination with an additive as benzoyl peroxide, and then cooled to room temperature. A (liquid) syrup will be obtained, consisting of a solution of polymer in monomer. With respect to the mould or cell cast, each mould part typically comprises a flat inner surface facing the other mould part when clampingly connected such that a mould is formed. Such mould part may for example be a panel or a plate. When the word gasket is used within the context of the present invention, it can also be referred to a (peripheral) hank. Further regarding the terminology of the gasket, the non-limiting terms profile, strand, cable, wire or rope may also be used within the context of this invention. More in particular, for example a profile or rope comprising PMMA may be used to form a gasket according to the present invention.

In a preferred embodiment of the method, at least part of the gasket comprises extruded polymethyl methacrylate. However, it is also possible that a gasket is used which is substantially fully made of extruded PMMA. It may be beneficial to use extruded PMMA since extruded PMMA is a relatively soft material and relatively easily processable into desired dimensions. Extruded PMMA has a lower melting temperature than PMMA in its cast form. Further, extruded PMMA benefits from being relatively easily thermoformable, having a good impact resistant and of being relatively inexpensive. A consequence of using extruded PMMA is that merging of the PMMA of the gasket and the (P)MMA of the to be produced plate may occur. Hence, at least part of the extruded PMMA gasket may dissolve in the MMA liquid during production of the PMMA plate, such that an intermediate layer of cast and extruded PMMA is formed. The intermediate layer then comprises a mixed fraction of cast PMMA and extruded PMMA. In any case, whether or not a mixed fraction of different polymer types is present, a residue (or scrap) comprising both casted PMMA and extruded PMMA is be obtained when using above described gasket for producing a PMMA cast plate. Separation of the different types of polymers can for example be applied, for example via separation, if separation is required for recycling and/or depolymerisation. It is also conceivable that simultaneous depolymerisation and/or recycling of the mixed fraction of extruded and cast PMMA, and thus hard and soft PMMA, is applied.

In a further possible embodiment of the method according to the invention, it is conceivable that the gasket comprises at least one additive. The additive is preferably configured to impede dissolution of polymethyl methacrylate of the gasket into the liquid comprising methyl methacrylate prepolymer and/or methyl methacrylate monomer during step B and/or step C). It is also conceivable that the gasket comprises PMMA which is co-extruded with at least one additive. This embodiment allows that the acrylic grade of the gasket can be modified in order to further adapt the material properties of the gasket. It is for example possible that said additive influences the melting properties of the PMMA, such that dissolution of PMMA in the MMA can be prevented or at least impeded. Hence, merging between hard and soft PMMA may be prevented. This can be beneficial with respect to the recycling process of the scrap in a later stage. It is also possible that an additive is used which affects the texture, flexibility and/or impact resistance of the gasket. This may positively influence the deformability, sealing capacity and/or workability of the gasket. Non-limiting examples of additives which can be used are a co-polymer, a plasticizer, an impact modifier, a polymerization primer and/or a resin. It is for example conceivable that polybutyl acrylate (PBA) and/or polyvinylidene fluoride (PVDF) are used as additive. It is further experimentally found that high molecular PMMA can be used as additive for the gasket. The high molecular PMMA is found to reduce the solvability of PMMA in MMA. Hence, it can be prevented that MMA is escaped from the mould prior to polymerization. When it is referred to high molecular PMMA, also high molecular weight PMMA is meant. A non-limiting example of a high molecular PMMA additive are dental grade pearls.

Further non-limiting examples of additives which can be applied in the method according to the present invention are polyethylene (PE) and/or polypropylene (PP). A further possibility is the use of an additive comprising a copolymer of ethylene and methacrylic acid. Such copolymer is for example known under the commercial name Surlyn. The use of said possible additives still allows for recycling and/or depolymerisation of the PMMA scrap. However, an extra additional purification step might be required in order to obtain the depolymerized product of the additive from the PMMA. The amount of additive applied in the gasket can for example be between 0.5 and 90 wt %. It is in particular conceivable that the amount of additive applied in the gasket is between 5 and 50 wt %, in particular between 10 and 40 wt %, more in particular between 20 and 30 wt %.

In a further preferred embodiment of the method is a gasket used, wherein at least part of the gasket is hollow. The gasket used may for example be a substantially tubular gasket. This embodiment is beneficial due to less material being required, resulting consequently in that less residue or scrap is left over. The gasket being at least partially hollow also benefits of more flexibility, making the gasket better workable for example during construction of the mould and/or during introducing liquid in the mould and/or spreading the liquid within the mould. A further benefit of at least part of the gasket being hollow is that such gasket deforms more easily compared to a solid gasket resulting in that a larger contact area between the gasket and the parallel mould parts during use can be obtained. A larger contact area between the gasket and the mould parts will provide a more stable mould configuration and may therefore result in that leakages of liquid MMA prepolymer during the production of the plate can be prevented.

It is possible the gasket comprises recycled polymethyl methacrylate. This is beneficial from environmental point of view. By using recycled PMMA the use of virgin plastic can, at least partially, be omitted. The recycled PMMA can for example be scrap material obtained when applying the method according to the present invention. It is also possible that the gasket comprises both virgin and recycled PMMA. Virgin PMMA may for example contribute to the strength of the gasket.

It is further conceivable that at least one sleeve encloses the gasket. Such sleeve is preferably configured to form a protective layer, in particular a protective film layer, around the gasket. Hence, the sleeve can prevent that PMMA of the gasket dissolves in the MMA. The sleeve is preferably a polymer sleeve. The sleeve may for example comprise polyethylene, such as but not limited to HDPE, LDPE and/or LLDPE. The sleeve can substantially fully enclose the gasket, hence, the gasket can be fully surrounded by the sleeve. Due to the sleeve enclosing the gasket, the use of an adhesive is generally not required. The sleeve can be provided around the gasket prior to the gasket being provided in the mould. The sleeve can also be referred to as cover. The sleeve may for example have a wall thickness in the range of 0.2 to 3 mm. It is for example conceivable that the sleeve has a wall thickness in the range of 0.2 to 1.0 mm, or from 1.0 to 2 mm, or from 1.5 to 3 mm.

The method may further comprise the step of cutting at least one and preferably each edge parts of the polymethyl methacrylate plate such that at least the gasket is removed from the plate. Hence, a plate of casted PMMA is obtained. This can be done via cutting or trimming. In particular, the gasket and part of the edges of the fabricated PMMA plate are removed. This removed scrap or residue contains PMMA from the produced plate in combination with PMMA of the gasket used in the mould. Since the gasket according to the present invention comprises PMMA, the scrap mainly and possibly substantially fully consists of PMMA. This results in the scrap being relatively easily processable for further application. Hence, the method according to the present invention substantially provides a single residual flow.

The present invention also relates to a polymethyl methacrylate plate produced via the method as described above. When it is referred to plate, both the intermediate assembly of the plate and the gasket and the finalized cut plate whereof the gasket is removed can be meant. Such finalized cut plate is typically subjected to at least one further processing step in order to manufacture a final product. The PMMA plate can for example be subjected to thermoforming.

The invention furthermore relates to a gasket for use in a mould for producing a polymethyl methacrylate plate, preferably via a method according to the present invention as described above, wherein the gasket comprises polymethyl methacrylate. The invention also relates to the use of a gasket comprising polymethyl methacrylate in a continuous casting process for producing a PMMA plate. The gasket according to the present invention can fully replace a conventional PVC gasket or any conventional gasket made of any further material. This is beneficial for several reasons, among which from an environmental point of view. As mentioned above, typically the circumferential sides or edges of a casted PMMA plate are removed after the casting in order to obtain a final product in the form of an uncontaminated PMMA plate. The removal of the edges can for example be done by a cutting process. The leftovers are PMMA scrap from the produced plate in combination with the PMMA gasket used in the mould. Since the gasket according to the present invention contains PMMA, the leftovers or residue mainly and possibly substantially fully consists of PMMA. This results in the residue or scrap being relatively easily processable for further application. The PMMA residue can for example be recycled and/or depolymerized. Several known techniques can be applied for the recycling and/or depolymerization of PMMA. Known techniques wherein MMA with a purity of more than 98% is obtainable can be applied. It is in particular beneficial if the recycled and/or depolymerized PMMA can be reused in a method and/or a gasket as disclosed in the present invention.

In a further possible embodiment, it is conceivable that at least part of the gasket comprises extruded polymethyl methacrylate. It is also possible that the gasket according to the present invention is substantially fully made of extruded PMMA. It may be beneficial to use extruded PMMA since extruded PMMA is a relatively soft material and relatively easily processable into desired dimensions. Extruded PMMA has a lower melting temperature than in its cast form. Further, extruded PMMA benefits of being relatively easily thermoformable, having a good impact resistant and of being relatively inexpensive. A consequence of using extruded PMMA is that merging of the PMMA of the gasket and the (P)MMA of the to be produced plate may occur. At least part of the extruded PMMA gasket may dissolve in the (P)MMA liquid during production of the PMMA plate, such that an intermediate layer of cast and extruded PMMA is formed. In any case, whether or not a mixed fraction of different polymer types is present, a residue comprising both casted PMMA and extruded PMMA is obtained when using above described gasket for producing a PMMA cast plate. Separation of the different types polymers can for example be performed, for example via separation, if separation is required for recycling and/or depolymerization. It is also conceivable that simultaneous depolymerization of the mixed PMMA fraction is applied. Despite the gasket can be substantially fully made of (extruded) PMMA, it is also possible that the gasket comprises at least one additive. Non-limiting examples of possible additives which can be used in a gasket according to the present invention are mentioned above.

It may be beneficial if at least part of the gasket is hollow. Non-limitative examples of possible embodiments of a hollow gasket are shown in the figures. As outlined above, at least part of the gasket being hollow is beneficial for economic reasons due to less material being required, resulting consequently in a more material efficient product and in less residue or scrap. The gasket being at least partially hollow also benefits of more flexibility, making the gasket better workable for example during construction of the mould. A further benefit of at least part of the gasket being hollow is that such gasket deforms more easily compared to a solid gasket, which may result in that a larger contact area between the gasket and the parallel mould parts during use can be obtained. In practice, the width-to-depth ration of the gasket may increase for this embodiment when the gasket is (clampingly) engaged between two substantially parallel mould parts. A larger contact area between the gasket and the mould parts will provide a more stable mould configuration resulting in that leakages of liquid MMA prepolymer during the production of the plate can be prevented. The gasket can furthermore be at least partially flexible. This may positively contribute to the ease of use of the gasket. The gasket may have an elongated, preferably oval or rectangular, cross-section. The gasket may also be a substantially annular gasket. Non-limiting examples are shown in the figures.

In a further possible of the gasket according to the present invention, at least part of the outer surface of the gasket is profiled. In particular when the gasket comprises extruded PMMA, it is relatively easy to manufacture a gasket wherein at least part of the outer surface is profiled. The outer surface of the gasket being at least partially profiled may improve sealing between the gasket and the mould due to that a larger contact area between the gasket and a plate can be obtained. It may further enhance the bonding between the PMMA plate and the gasket. The outer surface of the gasket may for example be at least partially roughened.

It is conceivable that the width-to-depth ratio of the gasket when enclosed between two substantially parallel mould parts of a mould for producing a polymethyl methacrylate plate is at least 1.5, preferably at least 2, more preferably at least 2.5. This embodiment provides a relatively stable configuration of the mould. Due to the gasket is preferably made of relatively soft PMMA the gasket has a relatively good deformability. Hence, the width-to-depth ration of the gasket in its initial form is typically lower than the width-to-depth ration when enclosed between the two substantially parallel mould parts of a mould for producing a PMMA plate. This is beneficial for the leak-tightness of the mould configuration.

The gasket may further be enclosed by at one sleeve, in particular a polymer sleeve. The sleeve may for example comprise polyethylene, such as but not limited to HDPE, LDPE and/or LLDPE. The sleeve can substantially fully enclose the gasket, hence, the gasket can be fully surrounded by the sleeve. The sleeve can be attached around the gasket and/or wrapped around the gasket. Due to the sleeve enclosing the gasket, the use of an adhesive is generally not required. The sleeve preferably form fittingly encloses the gasket. In such embodiment, the sleeve will not negatively affect the polymerization process. At least part of the outer surface of the sleeve could possibly be profiled.

The invention also relates to an assembly of at least part of a gasket according to the present invention and at least part of a polymethyl methacrylate plate. It is in particular referred to scrap, or residue, obtained by trimming a MPPA plate produced via the method according to the present invention according to any of the embodiments described above. The scrap can be a valuable product, since its PMMA composition allows it being subjectable to recycling and/or depolymerisation. The scrap may even be recycled and/or depolymerized and subsequently applied for the production of a new gasket for use in a similar method.

The invention also relates to a mould for producing a polymethyl methacrylate plate, preferably via a method as described above, comprising a gasket as described above, wherein the gasket is enclosed between two substantially parallel mould parts. The mould may further comprise at least one clamping element configured for providing a clamping engagement between the two parallel mould parts.

### DETAILED DESCRIPTION OF THE PREFERRED EMBODIMENTS

The invention will be elucidated on the basis of non-limitative exemplary embodiments shown in the following figures.

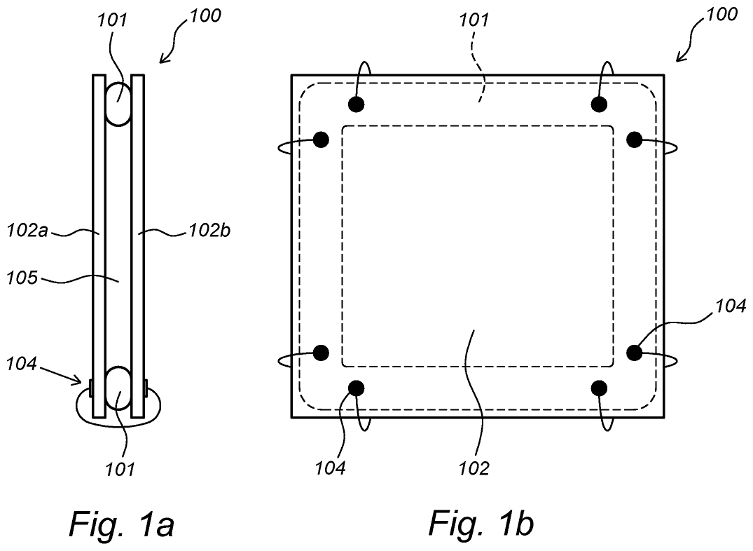

FIGS. 1a and 1b show a schematic representation of a mould 100 for producing a polymethyl methacrylate plate (not shown) according to the present invention for use in the method according to the present invention. FIG. 1a shows a side view of the mould 100, where FIG. 1b shows a top view. The mould 100 comprises two substantially parallel mould parts, in particular panels 102a, 102b preferably glass panels 102, and gasket 101. The substantially annular gasket 101 is enclosed between two substantially parallel panels 102a, 102b. The gasket 101 is clamped between the panels 102a, 102b via multiple clamping elements 104. Introduction of liquid comprising methyl methacrylate prepolymer and/or methyl methacrylate monomer into the mould 100 can be done via conventional methods. The liquid can for example be introduced into the receiving space 105 defined by the mould 100 before the panels 102a, 102b and the gasket 101 are fully clampingly connected via the clamping elements 104. The gasket 101 according to the present invention comprises (extruded) polymethyl methacrylate.

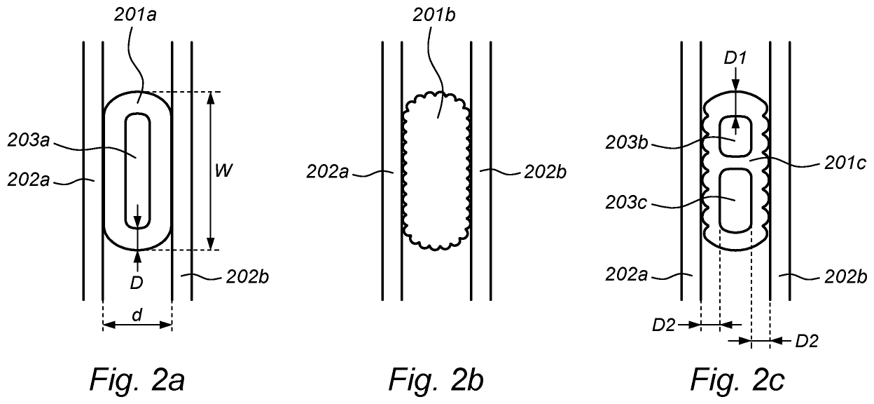

FIGS. 2a-2c show schematic representations of cross sections of possible embodiments of gaskets 201a, 201b, 201c according to the present invention. Each gasket 201a, 201b, 201c are enclosed between two parallel (glass) panels 202a, 202b.

FIG. 2a shows a gasket 201a being made of extruded PMMA wherein the gasket is hollow. Hence the gasket 201a shown is a substantially tubular gasket 201a. The wall of the gasket 201a encloses a hollow space 203a. The wall thickness D of the gasket 201a is substantially constant over the entire gasket 201a. It is however, also conceivable that the wall thickness locally varies, for example over the length and/or width of the gasket 201a. The width-to-depth ratio of the gasket is about 2, hence the width w of the gasket 201a is about twice the length of the depth d of the gasket 201a in the shown position wherein the gasket 201a is enclosed between the panels 202a, 202b.

FIG. 2b shows a PMMA gasket 201b wherein the outer surface of the gasket 201b is profiled. The outer surface of the gasket 201b comprises a (regular) pattern of little protrusions.

FIG. 2c shows a further embodiment of a hollow gasket 201c having an outer surface which is partially profiled. The profiling is present at the areas of the gasket 201c which are in contact with the panels 202a, 202b. The gasket 201c comprises two hollow spaces 203b, 203c. The wall thickness D1 of the wall facing inwardly is larger than the wall thickness D2 of the wall facing towards the parallel panels 202a, 202b. Swelling, or expanding of the gasket 201c may cause the area of the hollow spaces 203b, 203c to reduce.

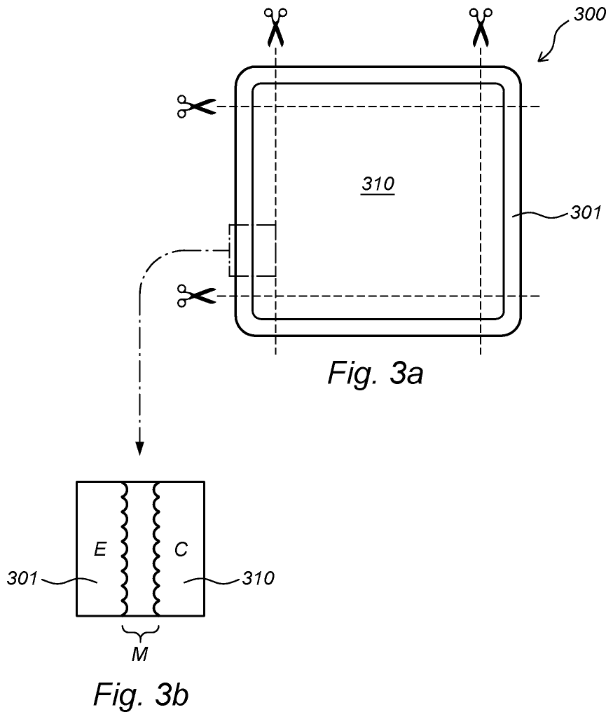

FIG. 3a show a PMMA plate 300 produced via a method according to the present invention. The panels of the mould are removed in the shown embodiment, such that a PMMA plate 310 which is enclosed by the gasket 301 remains. In order to provide a PMMA plate 310 which is usable for varies applications it is desired that the circumferential sides or edges of the plate 310 are removed. The cutting lines in the figure indicate where the plate 310 for example can be trimmed. The removed gasket 301 and part of the PMMA plate 310 form PMMA scrap.

FIG. 3b shows a detailed view of an edge part of the PMMA plate 310 shown in FIG. 3a. Hence, FIG. 3b show part of the scrap or residue formed after trimming. The gasket 301 comprises extruded PMMA. The figure shows that the MMA monomer or MMA prepolymer before polymerization has caused part of the PMMA of the gasket 301 to dissolve in the MMA liquid. Hence, after polymerization a region M comprising a mixture of cast PMMA (C) of the plate 310 and extruded PMMA (E) of the gasket 301 is obtained. The It is also conceivable that depolymerization of the mixed fraction of hard and soft PMMA is performed.

Hence, the above-described inventive concepts are illustrated by several illustrative embodiments. It is conceivable that individual inventive concepts may be applied without, in so doing, also applying other details of the described example. It is not necessary to elaborate on examples of all conceivable combinations of the above-described inventive concepts, as a person skilled in the art will understand numerous inventive concepts can be (re)combined in order to arrive at a specific application.

It will be apparent that the invention is not limited to the working examples shown and described herein, but that numerous variants are possible within the scope of the attached claims that will be obvious to a person skilled in the art.

The verb “comprise” and conjugations thereof used in this patent publication are understood to mean not only “comprise”, but are also understood to mean the phrases “contain”, “substantially consist of”, “formed by” and conjugations thereof.

1. Method for producing a polymethyl methacrylate plate, comprising the steps of:
A) providing a mould comprising at least two mould parts, each mould part having at least one substantially flat mould surface facing an substantially flat mould surface of an opposing mould part, and wherein said mould comprises at least one gasket, which gasket comprises polymethyl methacrylate, and which gasket is clamped in between said substantially flat mould surfaces of opposing mould parts, such that a mould cavity is defined by said mould parts and said gasket,
B) at least partially filling the mould cavity by introducing liquid comprising methyl methacrylate prepolymer and/or methyl methacrylate monomer into the mould cavity,
C) polymerization of the methyl methacrylate prepolymer and/or methyl methacrylate monomer introduced in the mould cavity, such that a polymethyl methacrylate plate, enclosed by said gasket, is formed within said mould cavity, and
D) removal of the assembly of the gasket and said polymethyl methacrylate plate enclosed by said gasket from the mould parts.

2. Method according to claim 1, wherein at least part of the gasket comprises extruded polymethyl methacrylate, and wherein the gasket is preferably substantially fully made of extruded polymethyl methacrylate.

3. Method according to claim 2, wherein the gasket comprises at least one additive configured to impede dissolution of polymethyl methacrylate of the gasket into the liquid comprising methyl methacrylate prepolymer and/or methyl methacrylate monomer during step B and/or step C).

4. Method according to claim 1, wherein the gasket has an elongated, preferably oval or rectangular, cross-section.

5. Method according to claim 1, wherein at least part of the gasket is hollow.

6. Method according to claim 1, wherein the gasket is an annular gasket.

7. Method according to claim 1, wherein at least part of the outer surface of the gasket is profiled.

8. Method according to claim 1, wherein the width-to-depth ratio of the gasket when clamped in between two substantially flat mould part surfaces is at least 1.5, preferably at least 2, more preferably at least 2.5.

9. Method according to claim 1, wherein the gasket comprises recycled polymethyl methacrylate.

10. Method according to claim 1, wherein at least one sleeve encloses the gasket.

11. Method according to claim 1, wherein opposing mould surfaces of the mould have a substantially parallel orientation, at least during step C).

12. Method according to claim 1, wherein during step C) the gasket is bound to the polymethyl methacrylate plate.

13. Method according to claim 12, further comprising step E), which comprises the step of cutting at least one and preferably each edge part of the polymethyl methacrylate plate such that at least the gasket is removed from the plate.

14. Method according to claim 13, wherein during step E) at least one and preferably each edge part of the polymethyl methacrylate plate such that both the gasket and a peripheral portion of the polymethyl methacrylate plate, bound to said gasket, are removed.

15. Polymethyl methacrylate plate produced via the method of claim 1.

16. Gasket for use in a mould for producing a polymethyl methacrylate plate via the method of claim 1, wherein the gasket comprises polymethyl methacrylate.

17. Assembly of at least part of a gasket according to claim 16 and at least part of a polymethyl methacrylate plate bound to said gasket.

18. Mould for use in a method for producing a polymethyl methacrylate plate, according to claim 1, comprising at least two mould parts, each mould part having at least one substantially flat mould surface facing an substantially flat mould surface of an opposing mould part, and wherein said mould comprises at least one gasket, which gasket comprises polymethyl methacrylate, and which gasket is clamped or clampable in between said substantially flat mould surfaces of opposing mould parts, such that a mould cavity is defined by said mould parts and said gasket.
